(19) United States
(12) Patent Application Publication
(10) Pub. No.: US 2014/0114614 A1
(43) Pub. Date: Apr. 24, 2014

(54) REMOTE MONITORING SYSTEM, REMOTE MONITORING APPARATUS, COMMUNICATION APPARATUS, AND REMOTE MONITORING METHOD

(71) Applicant: KABUSHIKI KAISHA TOSHIBA, Tokyo (JP)

(72) Inventors: Toshio Ito, Kanagawa-ken (JP); Yu Kaneko, Kanagawa-ken (JP)

(73) Assignee: KABUSHIKI KAISHA TOSHIBA, Tokyo (JP)

(21) Appl. No.: 14/037,589

(22) Filed: Sep. 26, 2013

(30) Foreign Application Priority Data
Oct. 18, 2012 (JP) 2012-231136

(51) Int. Cl. G01M 99/00

(52) U.S. Cl. CPC G01M 99/00
USPC 702/188

(57) ABSTRACT

According to some embodiments, there is provided a remote monitoring system including a plurality of communication apparatuses and a remote monitoring apparatus communicating with the communication apparatuses via a network, the communication apparatuses each managing at least one facility device. The remote monitoring apparatus includes a schedule creator, a transmitter and a receiver. The schedule creator creates event data transmitting schedules for the communication apparatuses based on a total bandwidth usable for communication with the communication apparatuses, each event data transmitting schedule indicating a time at which event data occurring in the facility device corresponding to the communication apparatus is allowed to be transmitted. The transmitter transmits the event data transmitting schedules to the communication apparatuses. The receiver receives event data messages each including the event data from the communication apparatuses.

### CROSS REFERENCE TO RELATED APPLICATIONS

This application is based upon and claims the benefit of priority from the prior Japanese Patent Application No. 2012-231136, filed on Oct. 18, 2012, the entire contents of which are incorporated herein by reference.

### FIELD

Embodiments described herein rebate to technologies of monitoring a plurality of facility devices at remote places via a network.

### BACKGROUND

Many facility devices are installed in a building accommodating offices, commercial facilities and the like. Such facility devices include illumination devices, air conditioning devices, elevators, escalators, and security and anti-disaster devices, which are monitored and controlled by a building management system. In recent years, there have been technologies that monitor and control the facility devices from a remote place via a communication network, such as the Internet. Through use of the technologies that remotely monitor and control the facility devices, the facility devices in many buildings can be controlled from a remote center residing at one place. Accordingly, building management services can be provided for each building at low cost.

In general, in a remote monitoring and controlling system for facility devices, a remote center repeatedly collects operation states of facility devices in buildings and data measured by sensor devices, thereby monitoring the facility devices. We call such data constantly generated by facility devices as process data. Monitoring facility devices by letting a remote center poll process data has an advantage that can improve the utilization of the communication band in process data collection by adjusting communication times among buildings.

However, to monitor the facility devices, monitoring of information generated by facility devices in response to certain triggers is important, as well as periodically collecting the process data. We call such data as event data. The event data includes, for instance, data notifying failures and abnormalities of the facility devices, and data notifying detection of disasters in case where anti-disaster devices detect the disasters. The event data has different characteristics from those of the process data. That is, the event data does not exist at a normal time, but is required to be detected as soon as possible in the case of occurrence of a specific event. Thus, according to a typical building management system, when a facility device detects an event, this device notifies a central monitoring system of event data thereof by itself.

Unfortunately, in the remote monitoring and controlling system, when the facility device transmits the event data to the remote center by itself at any time, there is a risk that events in many buildings occur at the same time, which makes the system unstable. In the case where events occur at the same time in many buildings, the event data transmitted from each building rushes to the remote center. This rush applies an excessive load to communication apparatuses and control apparatuses on the side of the remote center. Such situations not only hinder periodical collection of the process data by the remote center hut also cause a risk that the system crashes at worst to thereby stop building management services for all the buildings.

Conventionally, some methods of preventing a rush of data whose transmission time is unknown have thus been proposed. According to one method, first, a device (client) intending to request data transmission accesses an access time management server. The access time management server considers situations of loads on servers that receives the data, calculates an appropriate time when the client should transmit the data, and notifies the client of that time. The client waits until the notified time, and subsequently transmits the data to the server. This method can prevent concentration of loads due to data transmission. However, there is a problem in that if significantly many clients intend to transmit data at the same time, a waiting time until transmission becomes long unlimitedly.

According to another approach, a method can be considered in which the event data is also acquired by polling by the remote center as with the process data. In this case, in order to suppress a delay in detecting the event data to a sufficiently low level, the remote center is required to query the buildings about presence or absence of events at a period shorter than an allowable detection delay. However, as described above, the event data only exists when an event occurs. Accordingly, a query from the remote center by means of polling is useless in most cases. Such useless communication is undesirable, because this communication unnecessarily increases the load cost of communication apparatuses in the remote center and the buildings (referred to as building gateways).

As described above, the system that remotely monitors the facility devices in many buildings has a problem in that when the event data is transmitted from a large number of facility devices to be monitored at the same time, the system becomes unstable. Furthermore, conventional methods preventing this problem have another problem in that the detection delay of event becomes long, and an unnecessary load is applied to the devices in the buildings and the remote center.

### BRIEF DESCRIPTION OF THE DRAWINGS

FIG. 1 is a diagram showing an entire system configuration of a first embodiment;

FIG. 2 is a diagram showing an internal configuration of a remote center;

FIG. 3 is a diagram showing an example of building gateway information on a certain building gateway;

FIG. 4 is a diagram showing an example of a process data collecting schedule;

FIG. 5 is a diagram of an example of an event data transmitting schedule;

FIG. 6 is a diagram showing an operation flow of the remote center;

FIG. 7 is a diagram for illustrating a method of creating the event data transmitting schedule;

FIG. 8 is a diagram showing an example of a cumulative distribution function;

FIG. 9 is a diagram showing an internal configuration of the building gateway;

FIG. 10 shows a flowchart of an operation of the building gateway;

FIG. 11 is a diagram showing a form of a process data collecting schedule in a second embodiment;

FIG. 12 shows an operation flowchart of a remote center in the second embodiment;

FIG. 13 is a diagram showing an example of a transmitting schedule for putting event data in a process data message;

FIG. 14 is a diagram showing an internal configuration of a building gateway in the second embodiment; and

FIG. 15 shows an operation flowchart of the building gateway on the second embodiment.

### DETAILED DESCRIPTION

According to some embodiments, there is provided a remote monitoring system including a plurality of communication apparatuses and a remote monitoring apparatus communicating with the communication apparatuses via a network, the communication apparatuses each managing at least one facility device.

The remote monitoring apparatus includes a schedule creator, a transmitter and a receiver.

The schedule creator creates event data transmitting schedules for the communication apparatuses based on a total bandwidth usable for communication with the communication apparatuses, each event data transmitting schedule indicating a time at which event data occurring in the facility device corresponding to the communication apparatus is allowed to be transmitted.

The transmitter transmits the event data transmitting schedules to the communication apparatuses.

The receiver receives event data messages each including the event data from the communication apparatuses.

The communication apparatuses each include a receiver, a detector, a buffer and an event message transmitting controller.

The receiver receives the event data transmitting schedule from the remote monitoring apparatus.

The detector detects event data occurring in the facility device corresponding to the communication apparatus.

The buffer stores the event data detected by the detector.

The event message transmitting controller controls transmission of event data messages including the event data selected from the buffer to the remote monitoring apparatus according to the event data transmitting schedule.

Hereinafter, embodiments will be described with the accompanying drawings.

### First Embodiment

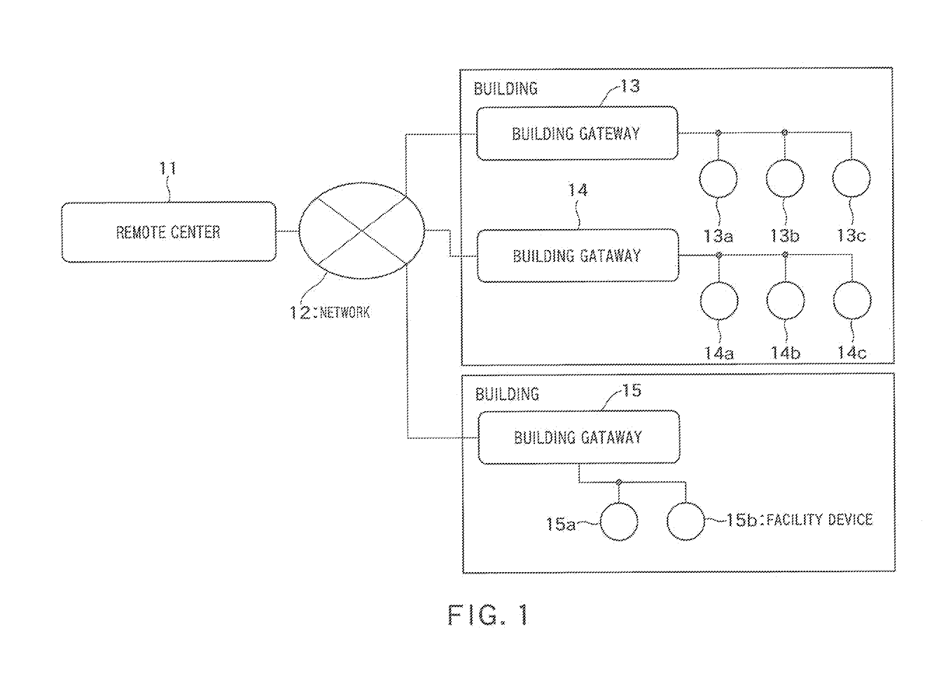

FIG. 1 shows an entire system configuration of a first embodiment. In this system, a remote center (remote monitoring apparatus) 11 remotely monitors facility devices in one or a plurality of buildings via a network 12. The facility devices residing in each building are managed by one or a plurality of apparatuses (communication apparatuses), which are referred to as building gateways. The remote center monitors the facility devices by directly communicating with each building gateway. The building gateways 13 and 14 are arranged in the same building. The building gateway 15 is arranged in another building. The building gateway 13 manages the facility devices 13a, 13b and 13c. The building gateway 14 manages the facility devices 14a, 14b and 14c. The building gateway 15 manages the facility devices 15a and 15b.

The remote center 11 periodically transmits request messages to the building gateways 13 to 15 in order to monitor process data of the facility devices. The building gateway, receiving the request message, acquires the requested process data of the facility devices, and replies a process data message including the process data as a response message to the remote center 11.

When event data occurs in the facility devices managed by building gateway 13 to 15, these gateways temporarily store the data and then transmit the data to the remote center 11 at an appropriate time. The remote center 11 preliminarily plans the appropriate times for transmitting the event data, as an event data transmitting schedule, on each building gateway, and notifies the building gateway.

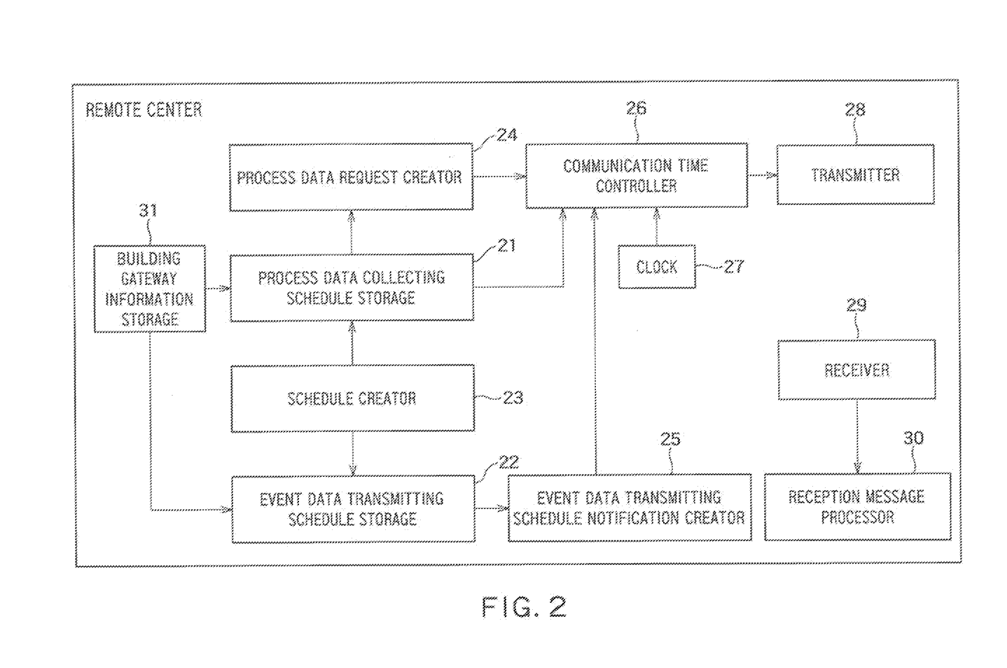

FIG. 2 illustrates an internal configuration of the remote center 11. The remote center 11 performs processes, such as creation of a schedule (process data collecting schedule) in the case of collecting the process data, creation of the event data transmitting schedule describing times when each building gateway is allowed to transmit the event data, transmission of a request message according to the process data collecting schedule, and reception of the message from each building gateway.

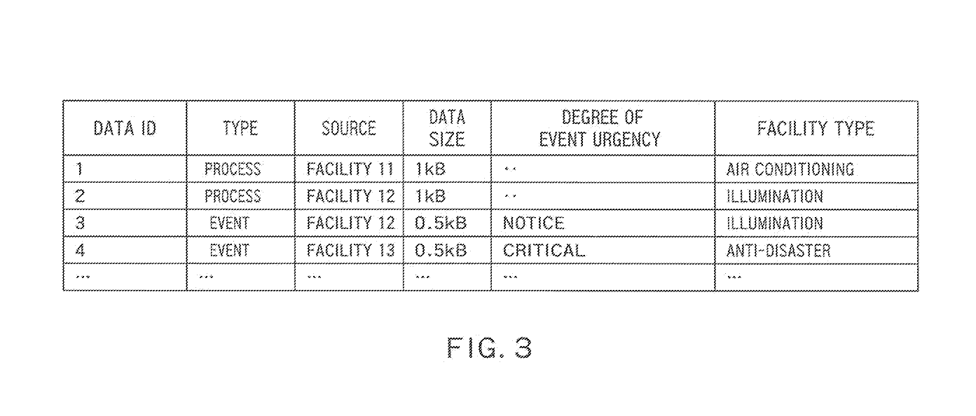

A building gateway information storage 31 stores building gateway information on each building gateway monitored by the remote center 11; this information indicates a list of the process data and the event data which are managed by the gateways. FIG. 3 shows an example of the building gateway information on a certain building gateway. As shown in the diagram, in terms of the data managed by the building gateway, information, such as a “data ID”, data “type”, facility as “source” of data, “data size”, “degree of urgency” of event data, and “facility type”, is managed. Such information is transmitted from administrators of the buildings or the building gateways to an administrator of the remote center 11 when the building gateway is connected to the remote center 11.

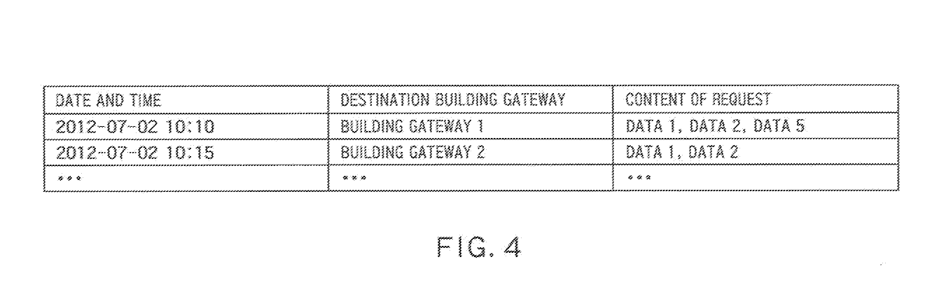

A process data collecting schedule storage 21 stores schedule data according to which the remote center it collects the process data of the facility devices from each building gateway. This schedule is referred to as a process data collecting schedule. FIG. 4 shows an example of the process data collecting schedule. As shown in the diagram, the process data collecting schedule describes when and which process data is collected from which building gateway. The process data to be requested to the building gateway is designated by referring to the “data ID” recorded in the building gateway information storage 31. The remote center 11 collects the process data according to the process data collecting schedule.

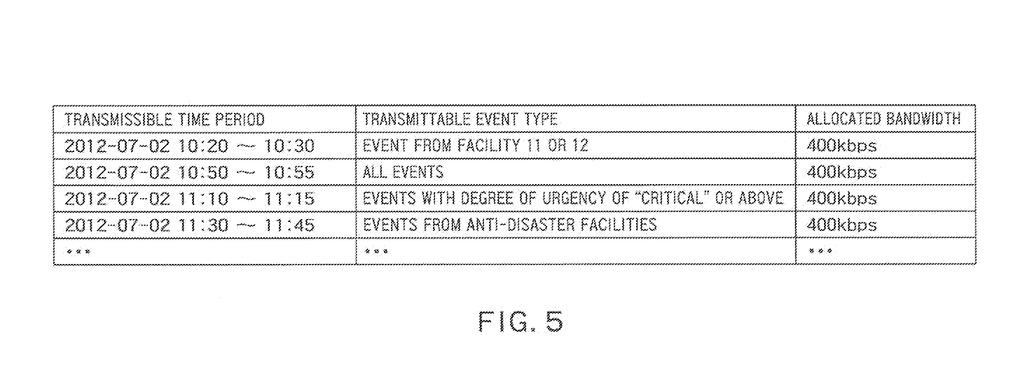

An event data transmitting schedule storage 22 stores schedule data describing time periods during which the event data is allowed to be transmitted, in terms of each building gateway. This schedule is referred to as an event data transmitting schedule. FIG. 5 shows an example of the event data transmitting schedule. The event data transmitting schedule in this diagram is for the building gateway shown in FIG. 3. This schedule describes “time periods” during which the building gateway is allowed to transmit the event data (starting time to finishing time), a pattern of events that can be transmitted in the time periods, and a “bandwidth” allocated to the time periods. In the case with the event data transmitting schedule in FIG. 5, if event data occurs from the facility 11, e.g., at 10:22 on Jul. 2, 2012, the building gateway immediately transmits the event data to the remote center. However, if event data occurs in the facility 11 at 10:45, transmission of the event data is not allowed at this time. Accordingly, the event data is temporarily accumulated in the building gateway. Subsequently, at 10:50, transmission of all kinds of events becomes allowed. Accordingly, the building gateway transmits the accumulated event data. Thus, each building gateway transmits the event data only in the time period allowed by the event data transmitting schedule, using the bandwidth allocated to the time period, but appropriately delays transmission of the event data occurring in another time period.

In the event data transmitting schedule, a transmittable event type can be set in each time period using, for instance, the following reference.

all events
events occurring in a specific facility device
events occurring In a specific type of facility devices
events occurring in facility devices installed in a specific physical position
events having a specific degree of urgency

A schedule creator 23 creates the process data collecting schedule, and the event data transmitting schedule for each building gateway. In this embodiment, the schedule creator 23 is included in the remote center 11. Instead, a configuration including the schedule creator 23 at the outside of the remote center may be adopted.

A process data request creator 24 reads the content of the request described in the process data collecting schedule, and creates a request message to be transmitted to the building gateway when the process data is collected.

An event data transmitting schedule notification creator 25 reads the event data transmitting schedule, and creates a message for notifying the building gateway that is a target of the schedule data.

A communication time controller (communication controller) 26 controls the message transmitted by the remote center 11 and the time thereof. More specifically, it refers to the process data collecting schedule and a clock, and, when the time for collecting the process data is reached, it acquires the request message from the process data request creator 24, and transmits the message to the destination building gateway. When an event data transmitting schedule notification message is received from the event data transmitting schedule notification creator 25, the message is transmitted to the destination building gateway.

A transmitter 28 is a function of transmitting various messages to the building gateway, and controlled by the communication time controller 26.

A receiver 29 receives the message transmitted from the building gateway, and transfers the message to a reception message processor 30. The messages transmitted from the building gateways are classified into two types, which are response messages (process data messages) to process data request messages, and event data messages.

The reception message processor 30 receives the message having received by the receiver 29, and performs an appropriate process according to the type of the message.

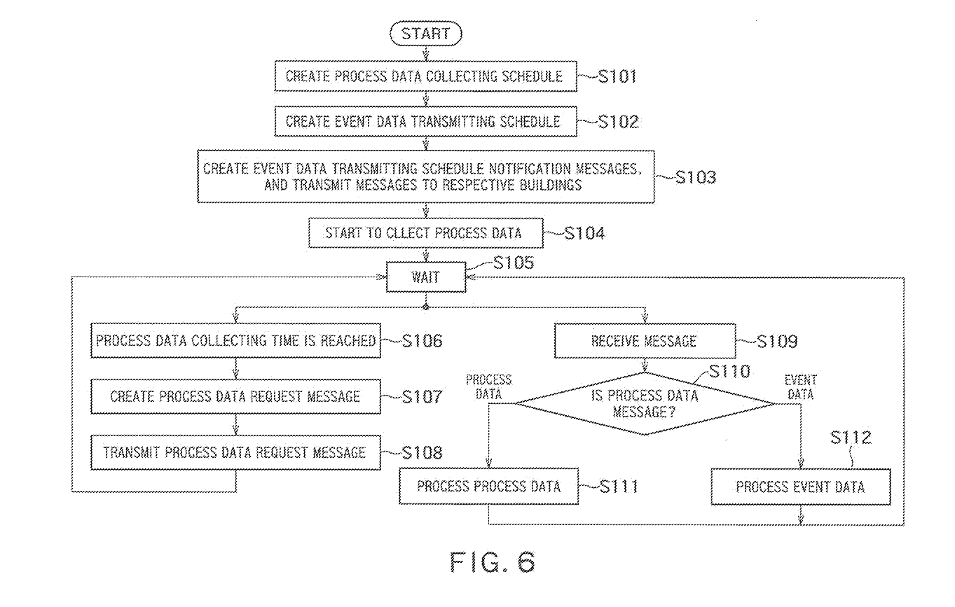

FIG. 6 shows an operation flow of the remote center 11.

After start of the operation, the remote center 11 causes the schedule creator 23 to create a process data collecting schedule (S101). When the process data collecting schedule is created, scheduling is performed such that data collection from many facility devices can be effectively and stably performed. In consideration of the number and types of facility devices to be monitored, the performance of each building gateway, the bandwidth of the network and the like. At this time, communication characteristics, such as a time span in which the request message for the process data is transmitted to the building gateway and the response message is returned, may be preliminarily measured and then the process data collecting schedule may be created using the measured communication characteristics.

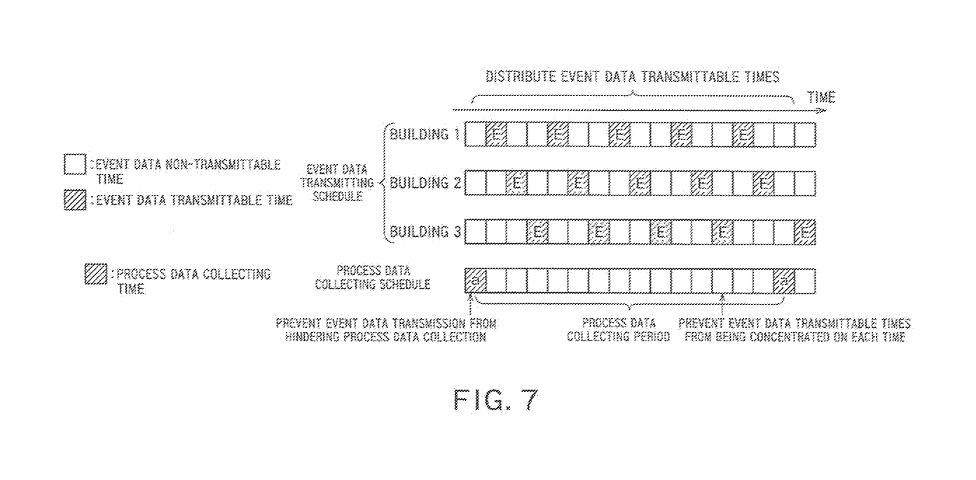

After creating the process data collecting schedule, the remote center then creates an event data transmitting schedule for each building gateway (S102). As shown in FIG. 7, the event data transmitting schedule is created in consideration of the following points.

The event transmittable times in the buildings and the facility devices are distributed such that, at any time, the sum of bandwidths allocated to the building gateways is smaller than the bandwidth of the system (the total bandwidth that is usable by the remote center for communication with each building gateway, and determined by facilities in the remote center and the performance of the network connecting the remote center to the building gateways). Even when event data occurs in many buildings and facility devices at the same time, this configuration can prevent overload due to a rush of the data to the remote center at one time.
The duration of the transmittable time period, the transmittable event type, and the allocated bandwidth are adjusted such that all the events can be transmitted as completely as possible within the time period. More specifically, it is preferable that the transmittable event type is adjusted so that the sum of the transmittable data size is lower than the transmission capacity calculated by multiplying the duration by the bandwidth. This configuration increases the possibility that all the transmittable events can be transmitted in time, and can suppress detection delay. The events selected according to the setting of the transmittable event type and the data size thereof can be acquired from the building gateway information storage 31.
Particularly, at a time when process data collection is scheduled, the type of the event data and the allocated bandwidth transmission of the event data are limited, in consideration of the communication bandwidth required for the process data collection and the processing capacity of the remote center. Even when event data occurs in many building and facility devices at the same time, this configuration can prevent transmission of the event data from hindering process data collection.
The transmittable time period for any piece of event data is set in a temporally distributed manner so as to be arranged at regular intervals as much as possible. The interval of the event data transmittable time periods is set to be shorter than the upper limit of detection delay allowed by the system. This configuration can suppress delay from occurrence of the event to transmission of the event data to be at or below the preset upper limit.

The method of creating the event data transmitting schedule, which has been described above, prevents the system from being subjected to an overload even when all the building gateways allowed to transmit event data actually transmit them.

However, some pieces of event data have a low possibility of occurring at the same time. For instance, it is regarded that the possibility of occurrence of events at the same time in different types of facility devices in two buildings geographically sufficiently apart from each other is low. The event transmittable times for such pieces of event data can be assigned to the same time period, which increases opportunities to transmit events and reduces the detection delay.

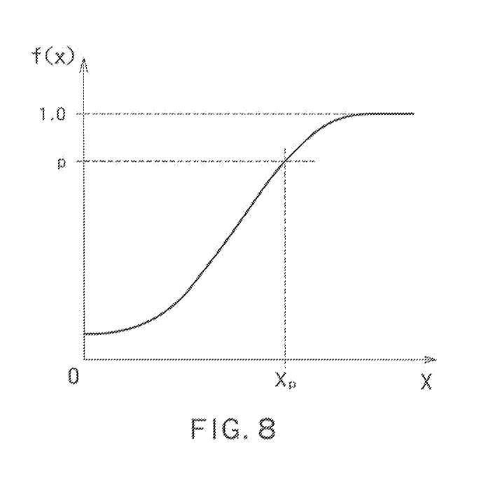

When the event data transmitting schedule is created in consideration of the event occurrence probability, the schedule can be created such that the probability of consumed bandwidth being higher than the upper limit is sufficiently low. To do that, probabilistic and statistical representative values of the sum of bandwidth allocated to a certain time are evaluated. In this case, the sum of bandwidths actually used by the building gateways in the allocated band is a stochastic variable. Let this stochastic variable be “X”. A method can be implemented that creates the schedule such that “E(X)”, the expectation of the consumed bandwidth, is below the upper limit of the bandwidth. The probability that “X” is equal to or less than a certain variable “x” is defined as “f(x)”. “f(x)” is a cumulative distribution function of “X”, and typically has a shape as shown in FIG. 8. Here, a method can be implemented that performs scheduling such that “xₚ” is below the upper limit of the bandwidth where p=f(xₚ) with the preset reliability probability “p”. When the schedule is thus created, the probability that the actually used sum of bandwidths is equal to or less than the upper limit of the system bandwidth is secured to be at least the reliability probability “p”.

The aforementioned method with reference to the sum of bandwidths allocated to the building gateways can be regarded as a specific case where the reliability probability “p” is one. Schedule creation using “p” where p<1 holds causes a possibility that transmission of the event data exceeding the upper limit of the system bandwidth occurs, but can increase opportunities to transmit the event data instead.

In this embodiment, the method has been described that creates the process data collecting schedule in advance and subsequently creates the event data transmitting schedule, as an example of creating the schedule. Instead, the schedule can be created in a different order. For instance, the process data collecting schedule may be created after the event data transmitting schedule is created. Two types of schedules may be created in a simultaneous and stepwise manner.

After the event data transmitting schedules for all the building gateways are created as described above, the remote center 11 notifies the building gateways of the schedules (S103). The building gateways notified of the event data transmitting schedule notification subsequently transmit the event data according to the respective schedules.

After completion of notifying the event data transmitting schedules, the remote center 11 starts to collect the process data (S104). The communication time controller 26 refers to a clock 27 and the process data collecting schedule, creates a process data request for the designated facility device at the time indicated by the process data collecting schedule, and transmits the request to the building gateway as the destination (S105, S106, S107 and S108).

While collecting the process data, the remote center receives messages transmitted from the building gateway (S105 and S109). The messages from the building gateway are classified into the process data message as a response to the process data request, and the event data message. If the reception message is the process data message (“process data” in S110), the received process data is stored in a database (S111). If the reception message is the event data message (“event data” in S110), the received event data is recorded and the content of the event is notified to the administrator of the remote center 11 (S112).

The internal structure and the operation flow of the remote center have thus been described.

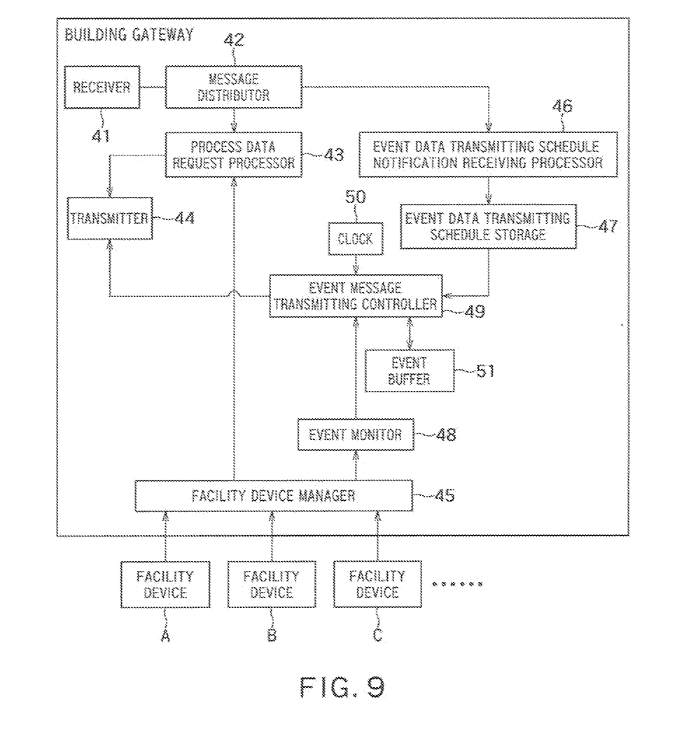

FIG. 9 shows an internal configuration of the building gateway. The building gateway transmits the process data in response to the process data request issued by the remote center 11, monitors event data occurring in the facility devices, and transmits the event data to the remote center at an appropriate time

A receiver 41 receives the message transmitted from the remote center 11, and passes the message to a message distributor 42.

The message distributor 42 discriminates whether the message is the process data request message or the event data transmitting schedule notification message, and transfers the message to an appropriate functional block.

The process data request message is transferred to a process data request processor 43. The process data request processor 43 acquires the process data of the requested facility device, from a facility device manager 45, and creates a response message to the remote center 11.

The event data transmitting schedule notification message is transferred to an event data transmitting schedule notification receiving processor 46. The event data transmitting schedule notification receiving processor 46 stores the received event data transmitting schedule in an event data transmitting schedule storage 47.

The event data transmitting schedule storage 47 holds the event data transmitting schedule in the building gateway.

The facility device manager 45 is directly connected to the facility devices, acquires the process data, and monitors events. The process data request processor 43 and an event monitor 48 of the building gateway can directly communicate with the facility device. However, according to a typical configuration, the facility device manager 45 collectively manages the facility devices in the building. A detector detecting event data occurring in the facility devices may be included in any one of the facility device manager 45 and the event monitor 48. In this embodiment, the detector is included in the facility device manager 45. In this embodiment, the facility device manager 45 is a function in the building gateway. Instead, a configuration where the facility device manager 45 exists out of the building gateway may be adopted.

The event monitor 48 monitors the event data from the facility device via the facility device manager 45. When the event monitor 48 detects occurrence of the event data, the event data is added to an event buffer 51, and occurrence of the event is notified to an event message transmitting controller 49.

The event message transmitting controller 49 refers to the event data transmitting schedule and a clock 50, and transmits the event data in the event buffer 51 at an appropriate time. The event data is transmitted such that the transmission data rate is adjusted within the bandwidth allocated by the event data transmitting schedule.

The event buffer 51 is a storage area in which the event data waiting to be transmitted is temporarily stored.

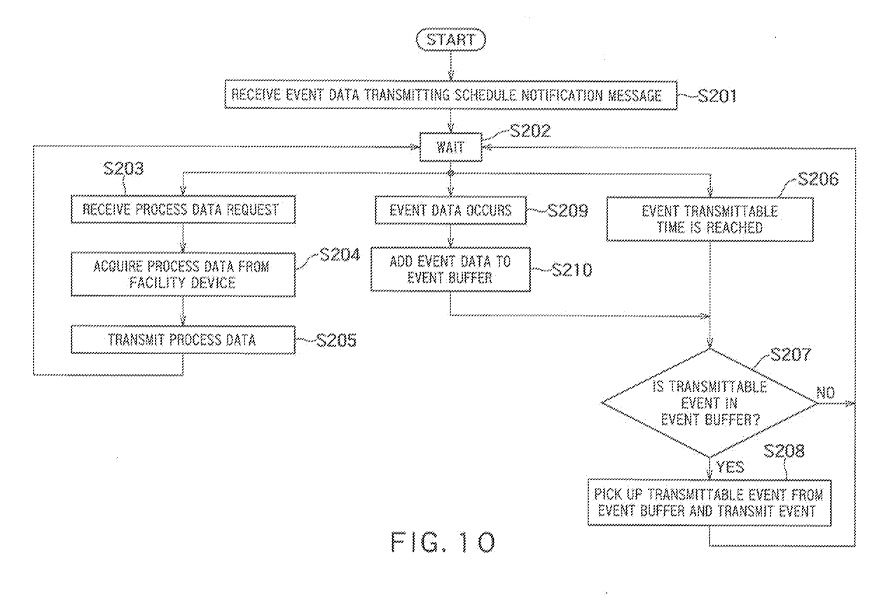

FIG. 10 shows a flowchart of an operation of the building gateway. First, the building gateway receives the event data transmitting schedule notification from the remote center 11 (S201). The received event data transmitting schedule is stored in the event data transmitting schedule storage 47.

Subsequently, the building gateway waits for the process data request issued by the remote center 11, and, when event data occurs in the facility device, the gateway processes the data.

More specifically, when the building gateway receives the process data request from the remote center 11, the gateway receives the process data of the facility device via the facility device manager 45, and transmits the data to the remote center 11 (S202, S203, S204 and S205).

When event data occurs in the facility devices (S209), the entire data is temporarily added to the event buffer 51 (S210). After the events are added to the event buffer 51, the building gateway refers to the clock 50 and the event data transmitting schedule, selects the event data transmittable at the time from the event buffer 51, and transmits an event data message including the event data (S207 and S208).

The event buffer 51 is a prioritized queue. The building gateway picks up the event data in a descending order of priority, and transmits the data. If the entire transmittable event data in the event data transmittable time period is failed to be transmitted completely, the pieces of event data failed to be transmitted remains in the event buffer 51, and are transmitted in a time period allowing the data to be transmitted, at the next time. The higher the “degree of urgency” of the event (see FIG. 3) is, the higher the priority of the event data is set. The longer the time elapsed from occurrence of the event, the higher the priority is set. Even in the case where a large amount of event data occurs, this configuration can suppress the delay (detection delay) from occurrence to transmission of the event as short as possible. In the case where the entire event data to be transmitted cannot be included in one event data message owing to restriction, such as of a protocol, the data may be distributed into a plurality of event data messages and transmitted.

If the storage area of the event buffer 51 is full when it tries to add a new event data to the buffer, the priorities of the event data in the event buffer 51 and the new event data are verified, and the event data with the lowest priority is discarded.

When the current time newly reaches the event data transmittable time period in the event data transmitting schedule (S206), the building gateway refers to the event buffer 51, and verifies whether the event data transmittable in the time period exists in the buffer 51 or not (S207). If such event data exists, the building gateway picks up the event data from the event buffer 51 according to analogous procedures as described above and transmits the data to the remote center 11 (S208).

The internal configuration and the operation flow of the building gateway have thus been described.

The above description has illustrated usual operations of the remote center 11 and the building gateways. Hereinafter, the cases where the buildings and facility devices to be monitored are added to or deleted from the remote center 11 will be described.

When the buildings and facility devices to be monitored by the remote center 11 are added or deleted, the remote center 11 re-creates a schedule in conformity to the change. More specifically, as described in FIG. 6, a process data collecting schedule is created (S101), an event data transmitting schedule is created (S102) and an event data transmitting schedule notification message is created and transmitted (S103). The remote center then collects the process data according to the re-created process data collecting schedule.

Meanwhile, when the building gateway receives the re-created event data transmitting schedule, the gateway subsequently transmits the event data on the basis of the schedule.

As described above, according to this embodiment, the event data occurring in the facility device to be monitored can be notified to the remote center with a short delay. Even when events occur in many facility devices at the same time, the event data can be prevented from rushing to the remote center. Accordingly, the event data can be collected without applying an excessive load. Even when events occur in many facility devices at the same time, the event data can be collected without hindering process data collection in the remote center. Polling from the remote center to the communication apparatus on the building side is unnecessary. Accordingly, the loads applied to the communication apparatuses on the building sides and the remote center can be suppressed. These advantageous effects are described further in detail as follows.

In this embodiment, the building gateway (apparatus to be monitored) includes: the event data transmitting schedule storage 22 that stores the event data transmitting schedule describing when the event data is allowed to be transmitted; and the event buffer 51. When the building gateway spontaneously transmits the data to the remote center (monitoring apparatus), the transmission is performed necessarily in the time period allowed by the event data transmitting schedule. The event data occurring in the time period during which transmission of the event data is prohibited according to the event data transmitting schedule is temporarily stored in the event buffer 51, and subsequently the data is transmitted in the time period during which transmission of the event data is allowed. This configuration can control the timing on which each building gateway transmits the event data, according to the event data transmitting schedule.

According to this embodiment, the event data transmitting schedule is created such that the maximum value, the expected value or another statistical representative value of the total sum of transmission bandwidths allocated to all the building gateways at any time is below the upper limit value allowed by the system. Even when events occur at the same time in many facility devices, this configuration can suppress the data rate of the transmission of the event data occurring at the same time at or below the upper limit allowed by the system, and prevent the event data from rushing to the remote center.

Furthermore, according to this embodiment, the event data transmitting schedule is created such that the interval of the time periods during which any type of event data can be transmitted is at or below the upper limit allowed by the system. The interval of the time periods during which the event data can be transmitted is the maximum value of the detection delay, which is from occurrence to transmission of the event data. Accordingly, the detection delay of any piece of event data can be suppressed at or below the upper limit allowed by the system.

Moreover, according to this embodiment, the remote center includes the process data collecting schedule storage 21 storing the process data collecting schedule, which describes the times when the request messages are transmitted to the building gateways. The center transmits the request messages to the building gateways according to the process data collecting schedule, thereby collecting the process data of the facility devices. Accordingly, the remote center can always monitor the process data of each facility device.

Furthermore, according to this embodiment, the event data transmitting schedule is created such that the maximum value, the expected value or another statistical representative value of the total sum of the transmission band widths allocated to all the building gateways at any request transmitting time described in the process data collecting schedule is below the upper limit allowed by the system. Thus, the data rate of transmission of the event data occurring at the time when the remote center collects the process data can be suppressed at or below the upper limit. Accordingly, even when many events occur at the same time, the event data can be notified to the remote center without hindering the process data collection.

### Second Embodiment

The building gateway in the first embodiment transmits the event data occurring in the facility device necessarily only in the time period allowed by the event data transmitting schedule. Thus, the event data can be prevented from rushing to the remote center. However, the opportunities of transmitting the event data are reduced. Accordingly, there is a possibility that the detection delay of the event data, which ranges from occurrence of the event data to reception thereof by the remote center, is increased.

Thus, in a building gateway in a second embodiment, which will be described below, the event data accumulated in the event buffer can be shared on (or put in) the process data message and transmitted to the remote center. The shared transmission has an advantage that the overheads of establishment of TCP connection and transmission of a message header can be reduced, in comparison with the case of separately transmitting the process data message and the event data message. Accordingly, the shared transmission can increase the opportunities of transmitting the event data, and suppress the detection delay of the event data, almost without increasing the load of the communication process.

The overall configuration of the system in this embodiment is analogous to that in the first embodiment shown in FIG. 1. Accordingly, the illustration is omitted.

The internal configuration of the remote center of this embodiment is analogous to that in the first embodiment shown in FIG. 2. Accordingly, the illustration is omitted.

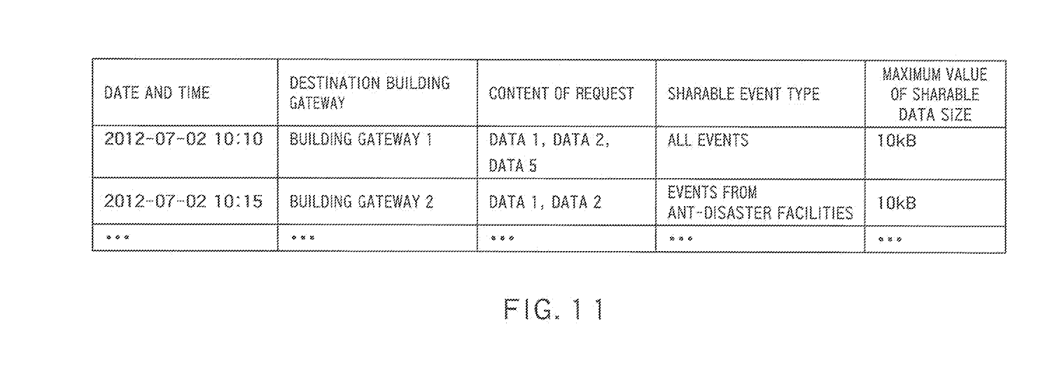

The remote center in this embodiment receives the event data included in the process data message. Accordingly, an event type sharable (or an event type which can be put) in the process data message is required to be notified to the building gateway. Thus, the process data collecting schedule in this embodiment has a form as shown in FIG. 11.

As shown in FIG. 11, the process data collecting schedule describes the event type sharable on the process data message, and the maximum value of the event data size allowed to be transmitted in a shared manner. The method of describing the event type is analogous to that of the transmittable event type in the event data transmitting schedule. Information on the sharable event type and the maximum value of the data size is included in the process data request message, and transmitted to the building gateway.

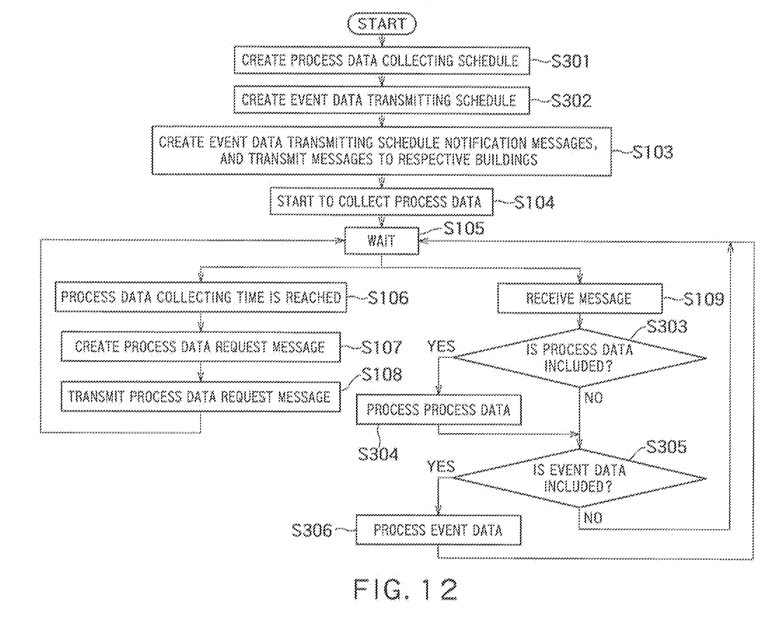

FIG. 12 shows an operation flowchart of the remote center of this embodiment. The difference from the operation of the remote center in the first embodiment shown in FIG. 6 is processes of creating the process data collecting schedule, creating the event data transmitting schedule, and receiving the message transmitted from the building gateway. The steps of performing the processes identical to those of the first embodiment are assigned with the identical symbols, and the redundant description is omitted.

In creation of the process data collecting schedule (S301), a process data collecting schedule is created according to a method analogous to that of the first embodiment, and the sharable event type and the maximum value of the sharable data size are set on each process data request. The maximum value of the sharable data size is determined in consideration of limitation on the protocol for the response message and the system bandwidth. It is preferable to set the sharable event type so that the total data size does not exceed the maximum value of the sharable data size even when all the selected events are transmitted.

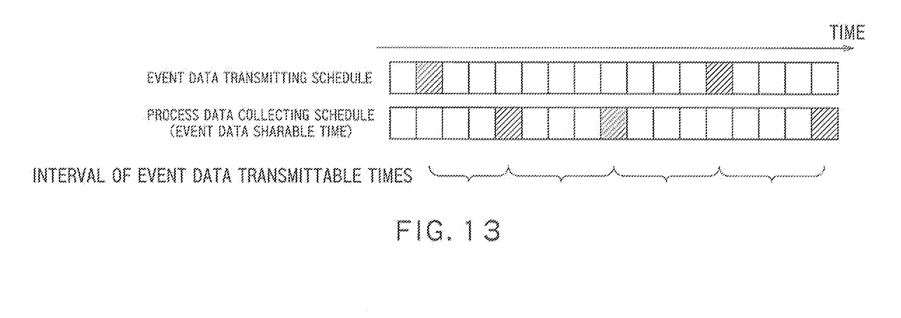

In creation of the event data transmitting schedule (S302), an event data transmitting schedule is created so as to satisfy points to be considered that have been described in the first embodiment. At this time, scheduling is performed in consideration of the sharable events described in the process data collecting schedule. In this case, as shown in FIG. 13, the transmittable times for any piece of the event data include both of the transmittable time period described in the event data transmitting schedule and the sharable times described in the process data collecting schedule. The event data transmitting schedule is created such that the thus defined event data transmittable times are set at regular intervals, and the interval of the event data transmittable times is below the upper limit of the detection delay of the event allowed by the system.

The remote center in this embodiment receives the process data message on which the event data is shared, and performs processes thereon. Accordingly, as shown in FIG. 12, upon receiving the message from the building gateway, the remote center verifies whether the message includes the process data and the event data or not (S303 and S305). If the data is included, appropriate processes as described in the first embodiment are performed on the respective pieces of data (S304 and S306).

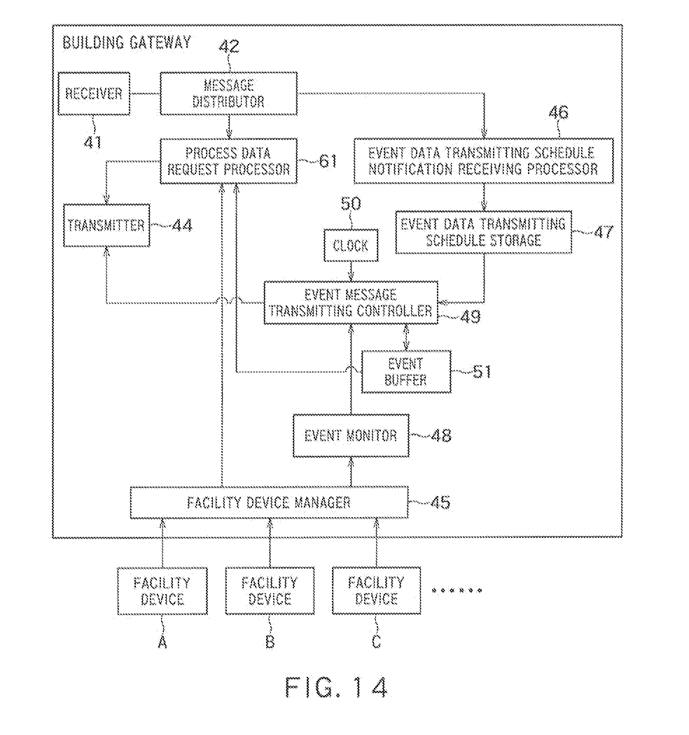

FIG. 14 shows a diagram of an internal configuration of the building gateway in this embodiment. The difference from the diagram of the internal configuration of the building gateway in the first embodiment shown in FIG. 9 is in that a process data request processor 61 refers to the event buffer 51. The steps of performing the processes identical to those in the first embodiment are assigned with the identical symbols. The redundant description is omitted.

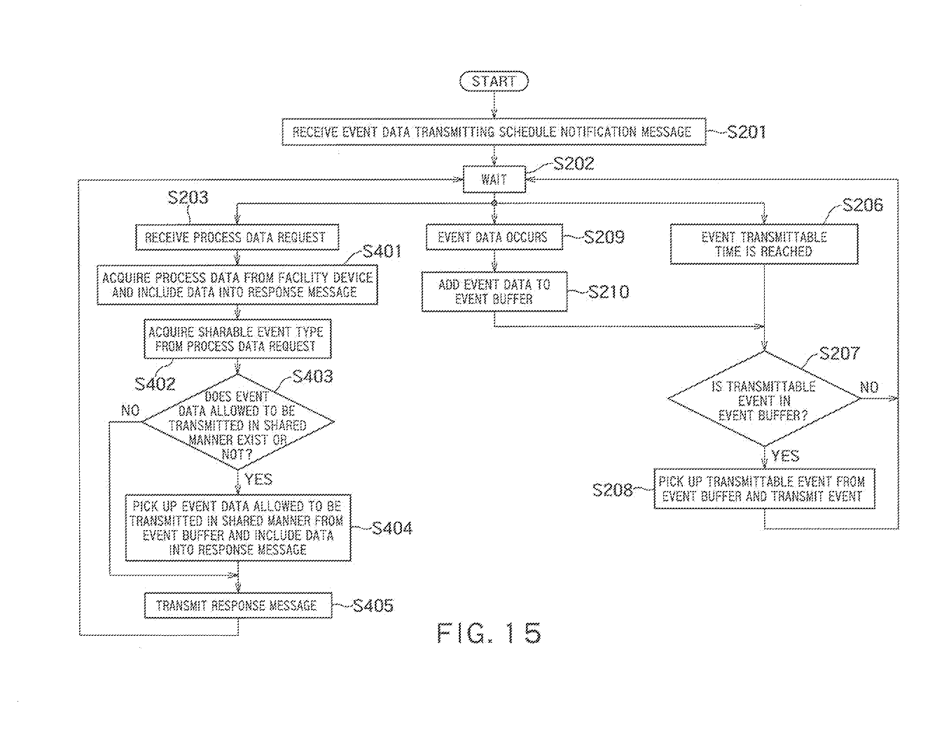

FIG. 15 shows an operation flowchart of the building gateway in this embodiment. The difference from the operation flowchart of the building gateway in the first embodiment shown in FIG. 10 is the operation upon receipt of the process data request from the remote center.

The building gateway in this embodiment receives the process data request message, acquires the process data, includes the process data into the response message (S401), and acquires the sharable event type included in the process data request message (S402). The building gateway refers to the information, and verifies whether the event data allowed to be transmitted in a shared manner exists in the event buffer 51 or not (S403). If the data exists, the gateway picks up the event data from the event buffer 51, and includes the data into the response message (S404). Finally, the gateway transmits the response message to the remote center (S405).

As described above, in the remote monitoring system in this embodiment, the building gateway can not only spontaneously transmit the event data in the time period allowed by the event data transmitting schedule but can also transmit the process data message on which the event data is shared.

The process data collecting schedule and the event data transmitting schedule of each building gateway can be created such that the interval of the transmittable times of any type of event data of each building gateway (the time allowed by the event data transmitting schedule, and the time when the event data is allowed to be put in a process data response message is below the upper limit allowed by the system.

Thus, the building gateway can include the event data into the process data response message, and transmit the message. Accordingly, the opportunities of transmitting the event data can be increased almost without increasing the load on the communication process. Furthermore, the process data collecting schedule and the event data transmitting schedule are created in consideration of increase in the transmission opportunities, thereby allowing the detection delay to be reduced without increasing the load on communication.

The remote center (remote monitoring apparatus) and the building gateway (communication apparatus) of this embodiment may also be realized using a general-purpose computer device as basic hardware. That is, they can be realized by causing a processor mounted in the above described computer device to execute a program. In this case, the remote center and the building gateway may be realized by installing the above described program in the computer device beforehand or may be realized by storing the program in a storage medium such as a CD-ROM or distributing the above described program over a network and installing this program in the computer device as appropriate. Furthermore, the storages in the remote center and the building gateway may also be realized using a memory device or hard disk incorporated in or externally added to the above described computer device or a storage medium such as CD-R, CD-RW, DVD-RAM, DVD-R as appropriate.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A remote monitoring system comprising a plurality of communication apparatuses and a remote monitoring apparatus communicating with the communication apparatuses via a network, the communication apparatuses each managing at least one facility device, wherein
the remote monitoring apparatus comprises:
a schedule creator configured to create event data transmitting schedules for the communication apparatuses based on a total bandwidth usable for communication with the communication apparatuses, each event data transmitting schedule indicating a time at which event data occurring in the facility device corresponding to the communication apparatus is allowed to be transmitted;
a transmitter configured to transmit the event data transmitting schedules to the communication apparatuses; and
a receiver configured to receive event data messages each including the event data from the communication apparatuses, and
the communication apparatuses each comprise:
a receiver configured to receive the event data transmitting schedule from the remote monitoring apparatus;
a detector configured to detect event data occurring in the facility device corresponding to the communication apparatus;
a buffer configured to store the event data detected by the detector; and
an event message transmitting controller configured to perform control so as to transmit an event data message including the event data selected from the buffer to the remote monitoring apparatus according to the event data transmitting schedule.

2. The system according to claim 1,
wherein the schedule creator creates event data transmitting schedules of the communication apparatuses so as to keep a statistical representative value of bandwidths to transmit the event data messages by the communication apparatuses below an upper limit value at any time.

3. The system according to claim 2,
wherein the statistical representative value is one of an expected value and a maximum value of a sum of the bandwidths to transmit the event data messages by the communication apparatuses at any time.

4. The system according to claim 1,
wherein the schedule creator creates event data transmitting schedules so as to keep a sum of bandwidths to transmit the event data messages by the communication apparatuses below an upper limit value with a reliability probability at any time.

5. The system according to claim 1,
wherein the schedule creator creates the event data transmitting schedule of the communication apparatus so as to keep an interval of times at which any type of the event data to be transmitted by the communication apparatus is allowed to be transmitted below an upper limit value.

6. The system according to claim 1,
wherein the remote monitoring apparatus further comprises a communication controller configured to perform control to transmit request messages to the communication apparatuses according to process data collecting schedules each of which is a schedule of collecting process data from a corresponding one of the communication apparatuses, and
the communication apparatuses each comprise: an acquisition unit configured to acquire process data from the facility device according to the request message received from the remote monitoring apparatus; and a transmitter configured to transmit a response message including the process data to the remote monitoring apparatus.

7. The system according to claim 6,
wherein the schedule creator creates the event data transmitting schedules and the process data collecting schedules so as to keep a statistical representative value of bandwidths to transmit the event data messages and the response messages transmitted by the communication apparatuses below an upper limit value at any time.

8. The system according to claim 7,
wherein the statistical representative value is one of an expected value and a maximum value of a sum of the bandwidths to transmit the event data messages and the response messages by the communication apparatuses at any time.

9. The system according to claim 6,
wherein the schedule creator creates the event data transmitting schedules and the process data collecting schedules so as to keep a sum of bandwidths to transmit the event data message and the response message by the communication apparatuses below an upper limit value with a reliability probability at any time.

10. The system according to claim 7,
wherein the communication apparatus stores the event data selected from the buffer in the response message together with the process data, and transmits the response message including both of the event data and the process data to the remote monitoring apparatus.

11. The system according to claim 10,
wherein the schedule creator creates the event data transmitting schedules and the process data collecting schedules so as to keep an interval of times at which any type of the event data transmittable by either of the event data message or the response message is allowed to be transmitted below an upper limit value.

12. A remote monitoring apparatus, comprising:
a schedule creator configured to create event data transmitting schedules for a plurality of communication apparatuses based on a total bandwidth usable for communication with the communication apparatuses, the event data transmitting schedules each indicating a time at which event data occurring in a facility device corresponding to the communication apparatus is allowed to be transmitted;
a transmitter configured to transmit the event data transmitting schedules to the communication apparatuses; and
a receiver configured to receive event data messages each including the event data from the communication apparatuses.

13. A communication apparatus, comprising:
a receiver configured to receive an event data transmitting schedule from a remote monitoring apparatus, the event data transmitting schedule indicating a time at which event data occurring in a facility device is allowed to be transmitted;
a detector configured to detect event data occurring in the facility device;
a buffer configured to store the event data detected by the detector; and
a transmitting controller configured to perform control so as to transmit an event data message including the event data selected from the buffer to the monitoring apparatus according to the event data transmitting schedule.

14. A remote monitoring method, comprising:
creating, by a remote monitoring apparatus, event data transmitting schedules for a plurality of communication apparatuses based on a total bandwidth usable for communication with the communication apparatuses, the event data transmitting schedules each indicating a time at which event data occurring in a facility device corresponding to each of the communication apparatuses is allowed to be transmitted;
transmitting, by the remote monitoring apparatus, the event data transmitting schedules to the communication apparatuses;
detecting event data occurring in the facility device corresponding to each of the communication apparatuses and storing the event data in a buffer in each of the communication apparatuses; and
transmitting, by the communication apparatuses, event data messages each including the event data selected from the buffers to the monitoring apparatus according to the event data transmitting schedules.
